(19) United States
(12) Patent Application Publication
(10) Pub. No.: US 2015/0356656 A1
(43) Pub. Date: Dec. 10, 2015

(54) MARKETPLACE LISTINGS ON PROCUREMENT TOOL

(71) Applicant: EBAY INC., San Jose, CA (US)

(72) Inventors: Marc Peter Hosein, Saratoga, CA (US); Selina Lam, Castro Valley, CA (US)

(21) Appl. No.: 14/586,394

(22) Filed: Dec. 30, 2014

Related U.S. Application Data
(60) Provisional application No. 62/010,378, filed on Jun. 10, 2014.

(51) Int. Cl. G06Q 30/06; G06Q 30/08

(52) U.S. Cl. CPC G06Q 30/0623; G06Q 30/0635; G06Q 30/0637; G06Q 30/08

(57) ABSTRACT

In an example embodiment, a request to view items for purchase is received, and then information about one or more items available for purchase via contract is retrieved from a database. Information about one or more items available for spot purchase from a marketplace system is then obtained via interface with one or more APIs. Then the information about one or more items available for spot purchase and the information about one or more items available for purchase via contract are displayed in a procurement tool.

### PRIORITY

This application is a Non-Provisional of and claims the benefit of priority under 35 §119(e) from U.S. Provisional Application Ser. No. 62/010,378, filed on Jun. 10, 2014 which is hereby incorporated by reference herein in its entirety.

### TECHNICAL FIELD

This application relates generally to procurement tools. More particularly, this application relates to a solution that presents marketplace listings on a procurement tool.

### BACKGROUND

Business-to-Business (B-to-B) transactions make up a large number of transactions conducted on the Internet. This may include businesses purchasing (for example, capital equipment or raw materials needed to conduct business). These types of B-to-B transactions conducted through the Internet are usually performed using a procurement tool. A procurement tool is a software application that permits a business to purchase goods or services on contract. Some B-to-B transactions, however, are not performed with contracts but are spot purchases. What is needed is a mechanism to permit spot purchases to be easily integrated into existing procurement tools.

### BRIEF DESCRIPTION OF DRAWINGS

FIG. 1 is a block diagram illustrating a system, in accordance with an example embodiment.

FIG. 2 is a network diagram depicting a client-server system, within which one example embodiment may be deployed.

FIG. 3 is a block diagram illustrating marketplace and payment applications that, in one example embodiment, are provided as part of application server(s) in the networked system.

FIG. 4 is a block diagram illustrating a procurement tool, in accordance with an example embodiment.

FIG. 5 is a ladder diagram illustrating a method for procuring spot purchase items, in accordance with an example embodiment.

FIG. 6 is a screen capture illustrating a procurement tool, in accordance with an example embodiment.

FIG. 7 is a screen capture illustrating a procurement tool, in accordance with another example embodiment.

FIG. 8 is a screen capture illustrating a procurement tool, in accordance with another example embodiment.

FIG. 9 is a screen capture illustrating a procurement tool, in accordance with another example embodiment.

FIG. 10 is a screen capture illustrating a procurement tool, in accordance with another example embodiment.

FIG. 11 is a screen capture illustrating a procurement tool in accordance with another example embodiment.

FIG. 12 is a flow diagram illustrating a method in accordance with an example embodiment.

FIG. 13 is a block diagram illustrating a mobile device, according to an example embodiment.

FIG. 14 is a block diagram of machine in the example form of a computer system within which instructions, for causing the machine to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, spot purchasing capability is integrated into a procurement tool by providing access to an online marketplace directly from the procurement tool. In an example embodiment, application program interfaces (APIs) are provided to feed real-time marketplace listings to the procurement tool.

In the procurement tools, there are different access levels and different workflows for various users. Employees may have one workflow, for example, and approvers, such as procurement agents, may have a different workflow.

In an example embodiment, each potential business purchaser opens an account with an online marketplace (and perhaps also an account with a payment provider) as part of an initial setup process. Once the account is created marketplace credentials (e.g., user name and password) are stored in the procurement tool.

Users of the procurement tool, who may be searching or browsing for a needed item or service, may be presented with results showing contracted goods or services available as well as results showing marketplace goods or services available for spot purchase. The spot purchase items may be presented in the same window as the contracted items, or alternatively they may be separated or otherwise delineated so as to distinguish between contracted items and spot purchase items.

Once the user is ready to purchase an item, the item can be added to a shopping cart. Upon checkout, the APIs can feed information to the online marketplace to add up taxes, shipping, and the like, and give a total purchase amount. The total can then be integrated back into the procurement tool's approval flow, where the total may need to be, for example, approved by various parties (e.g., information technology (IT) department, a procurement agent, etc.) The online marketplace can then obtain a purchase order generated by the procurement tool and use this to complete the purchase of the item and send back transaction information to the procurement tool, which can then in turn let the user know that the transaction has been completed.

In an example embodiment, the user may subscribe to shipment notifications which can be delivered either through the procurement tool or separately from the online marketplace. This allows the user to see the progress of the shipment of the item and track the item as it is being transported.

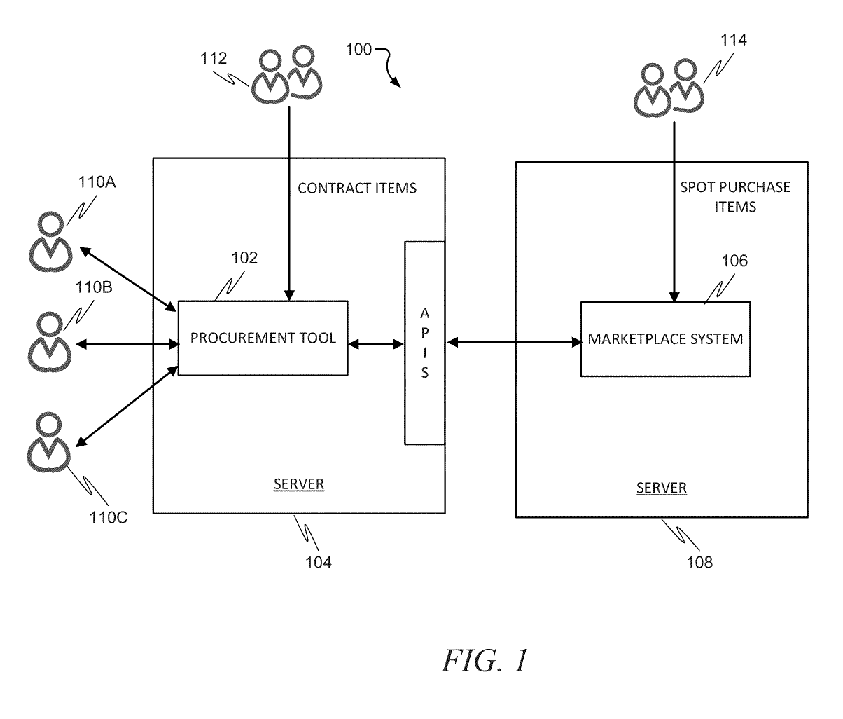

FIG. 1 is a block diagram illustrating a system 100, in accordance with an example embodiment. The system 100 includes a procurement tool 102 operating on a first server 104 and a marketplace system 106 operating on a second server 108. It should be noted that while first server 104 and second server 108 are depicted and described as individual servers, in an example embodiment the functionality of each may be distributed across any number of servers.

One or more users 110A-110C may interact with the procurement tool 102 to order items. These users 110A-110C may include, for example, an employee 110A, an IT person 110B, and a procurement agent 110C. In this example, employee 110A wishes to purchase an item. Suppliers 112 provide information about items available to purchase on contract to the procurement tool 102 while suppliers 114 provide information about items available to spot purchase to the marketplace system 106. The employee 110A is able to search and browse both sets of items from the procurement tool 102. Once an item is selected for purchase, approval may be obtained from both the IT person 110B and the procurement agent 110C, and the transaction may be completed.

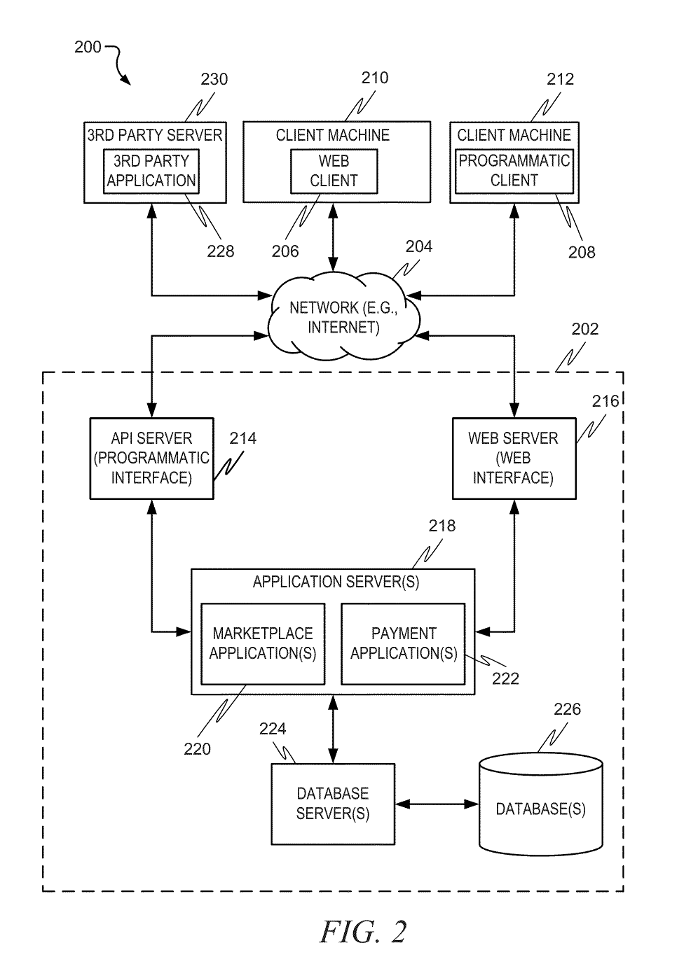

FIG. 2 is a network diagram depicting a client-server system 200, within which one example embodiment may be deployed. A networked system 202, in the example forms of a network-based marketplace or publication system, provides server-side functionality, via a network 204 (e.g., the Internet or a Wide Area Network (WAN)), to one or more clients. FIG. 2 illustrates, for example, a web client 206 (e.g., a browser, such as the Internet Explorer browser developed by Microsoft Corporation of Redmond, Wash. State) and a programmatic client 208 executing on respective devices 210 and 212, respectively.

An API server 214 and a web server 216 are coupled to, and provide programmatic and web interfaces respectively to, one or more application servers 218. The application servers 218 host one or more marketplace applications 220 and payment applications 222. The application servers 218 are, in turn, shown to be coupled to one or more database servers 224 that facilitate access to one or more databases 226. The application server(s) 218 may, in one example embodiment, correspond to marketplace system 106 of FIG. 1.

The marketplace applications 220 may provide a number of marketplace functions and services to users who access the networked system 202. The payment applications 222 may likewise provide a number of payment services and functions to users. The payment applications 222 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 220. While the marketplace and payment applications 220 and 222 are shown in FIG. 2 to both form part of the networked system 202, it will be appreciated that, in alternative embodiments, the payment applications 222 may form part of a payment service that is separate and distinct from the networked system 202.

Further, while the system 200 shown in FIG. 2 employs a client-server architecture, the embodiments are, of course, not limited to such an architecture, and could equally well find application in a distributed, or peer-to-peer, architecture system, for example. The various marketplace and payment applications 220 and 222 could also be implemented as standalone software programs, which do not necessarily have networking capabilities.

The web client 206 accesses the various marketplace and payment applications 220 and 222 via the web interface supported by the web server 216. Similarly, the programmatic client 208 accesses the various services and functions provided by the marketplace and payment applications 220 and 222 via the programmatic interface provided by the API server 214. The programmatic client 208 may, for example, be a seller application (e.g., the TurboLister application developed by eBay Inc., of San Jose, Calif.) to enable sellers to author and manage listings on the networked system 202 in an off-line manner, and to perform batch-mode communications between the programmatic client 208 and the networked system 202.

FIG. 2 also illustrates a third party application 228, executing on a third party server machine 230, as having programmatic access to the networked system 202 via the programmatic interface provided by the API server 214. For example, the third party application 228 may, utilizing information retrieved from the networked system 202, support one or more features or functions on a website hosted by the third party. The third party website may, for example, provide one or more promotional, marketplace, or payment functions that are supported by the relevant applications of the networked system 202.

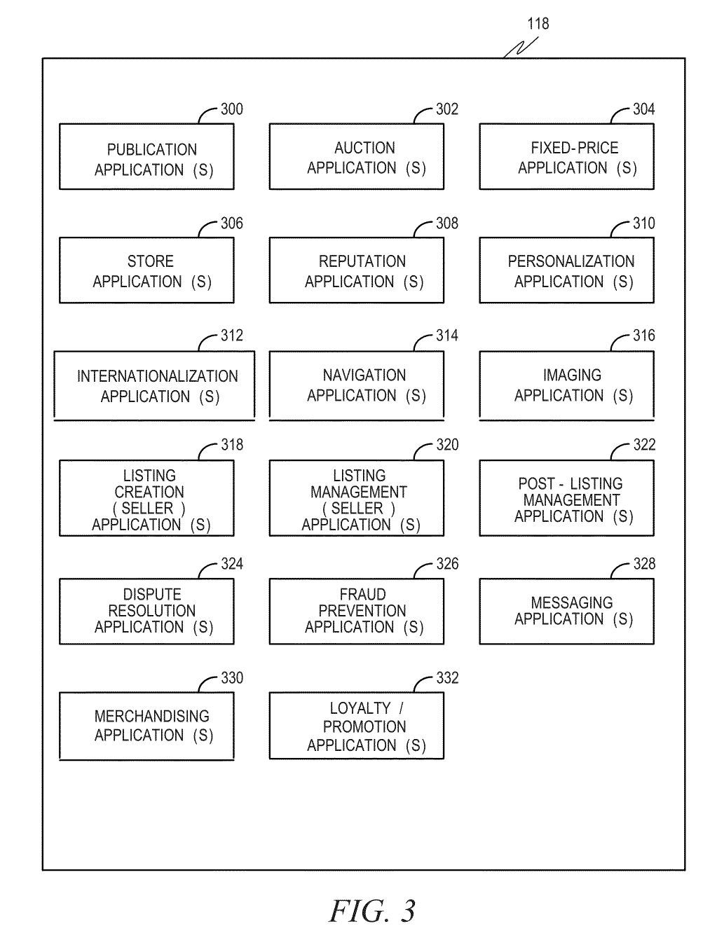

FIG. 3 is a block diagram illustrating marketplace and payment applications 220 and 222 that, in one example embodiment, are provided as part of application server(s) 218 in the networked system 202. The applications 220 and 222 may be hosted on dedicated or shared server machines (not shown) that are communicatively coupled to enable communications between server machines. The applications 220 and 222 themselves are communicatively coupled (e.g., via appropriate interfaces) to each other and to various data sources, so as to allow information to be passed between the applications 220 and 222 or so as to allow the applications 220 and 222 to share and access common data. The applications 220 and 222 may furthermore access one or more databases 226 via the database servers 224.

The networked system 202 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 220 and 222 are shown to include at least one publication application 300 and one or more auction applications 302, which support auction-format listing and price setting mechanisms (e.g., English, Dutch, Vickrey, Chinese, Double, Reverse auctions, etc.). The various auction applications 302 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 304 support fixed-price listing formats (e.g., the traditional classified advertisement-type listing or a catalogue listing) and buyout-type listings. Specifically, buyout-type listings including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 306 allow a seller to group listings within a “virtual” store, which may be branded and otherwise personalized by and for the seller. Such a virtual store may also offer promotions, incentives, and features that are specific and personalized to a relevant seller.

Reputation applications 308 allow users who transact, utilizing the networked system 202, to establish, build, and maintain reputations, which may be made available and published to potential trading partners. Consider that where, for example, the networked system 202 supports person-to-person trading, users may otherwise have no history or other reference information whereby the trustworthiness and credibility of potential trading partners may be assessed. The reputation applications 308 allow a user (for example, through feedback provided by other transaction partners) to establish a reputation within the networked system 202 over time. Other potential trading partners may then reference such a reputation for the purposes of assessing credibility and trustworthiness.

Personalization applications 310 allow users of the networked system 202 to personalize various aspects of their interactions with the networked system 202. For example a user may, utilizing an appropriate personalization application 310, create a personalized reference page at which information regarding transactions to which the user is (or has been) a party may be viewed. Further, a personalization application 310 may enable a user to personalize listings and other aspects of their interactions with the networked system 202 and other parties.

The networked system 202 may support a number of marketplaces that are customized, for example, for specific geographic regions. A version of the networked system 202 may be customized for the United Kingdom, whereas another version of the networked system 202 may be customized for the United States. Each of these versions may operate as an independent marketplace or may be customized (or internationalized) presentations of a common underlying marketplace. The networked system 202 may accordingly include a number of internationalization applications 312 that customize information (and/or the presentation of information by the networked system 202) according to predetermined criteria (e.g., geographic, demographic, or marketplace criteria). For example, the internationalization applications 312 may be used to support the customization of information for a number of regional websites that are operated by the networked system 202 and that are accessible via respective web servers 216.

Navigation of the networked system 202 may be facilitated by one or more navigation applications 314. For example, a search application (as an example of a navigation application 314) may enable key word searches of listings published the networked system 202. A browse application may allow users to browse various category, catalogue, or inventory data structures according to which listings may be classified within the networked system 202. Various other navigation applications 314 may be provided to supplement the search and browsing applications.

In order to make listings available via the networked system 202 as visually informing and attractive as possible, the applications 220 and 222 may include one or more imaging applications 316, which users may utilize to upload images for inclusion within listings. An imaging application 316 also operates to incorporate images within viewed listings. The imaging applications 316 may also support one or more promotional features, such as image galleries that are presented to potential buyers. For example, sellers may pay an additional fee to have an image included within a gallery of images for promoted items.

Listing creation applications 318 allow sellers to conveniently author listings pertaining to goods or services that they wish to transact via the networked system 202, and listing management applications 320 allow sellers to manage such listings. Specifically, where a particular seller has authored and/or published a large number of listings, the management of such listings may present a challenge. The listing management applications 320 provide a number of features (e.g., auto-relisting, inventory level monitors, etc.) to assist the seller in managing such listings. One or more post-listing management applications 322 also assist sellers with a number of activities that typically occur post-listing. For example, upon completion of an auction facilitated by one or more auction applications 302, a seller may wish to leave feedback regarding a particular buyer. To this end, a post-listing management application 322 may provide an interface to one or more reputation applications 308, so as to allow the seller to conveniently provide feedback regarding multiple buyers to the reputation applications 308.

Dispute resolution applications 324 provide mechanisms whereby disputes arising between transacting parties may be resolved. For example, the dispute resolution applications 324 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 326 implement fraud detection and prevention mechanisms to reduce the occurrence of fraud within the networked system 202.

Messaging applications 328 are responsible for the generation and delivery of messages to users of the networked system 202 (such as, for example, messages advising users regarding the status of listings at the networked system 202 (e.g., providing “outbid” notices to bidders during an auction process or to provide promotional and merchandising information to users)). Respective messaging applications 328 may utilize any one of a number of message delivery networks and platforms to deliver messages to users. For example, messaging applications 328 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 204.

Merchandising applications 330 support various merchandising functions that are made available to sellers to enable sellers to increase sales via the networked system 202. The merchandising applications 330 also operate the various merchandising features that may be invoked by sellers, and may monitor and track the success of merchandising strategies employed by sellers.

The networked system 202 itself or one or more parties that transact via the networked system 202, may operate loyalty programs that are supported by one or more loyalty/promotions applications 332. For example, a buyer may earn loyalty or promotion points for each transaction established and/or concluded with a particular seller, and be offered a reward for which accumulated loyalty points can be redeemed.

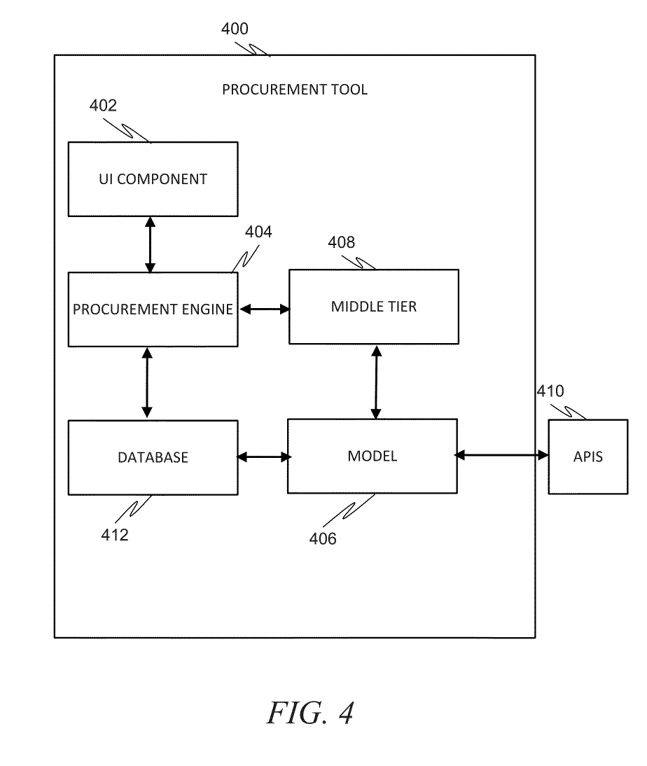

FIG. 4 is a block diagram illustrating a procurement tool 400, in accordance with an example embodiment. In some example embodiments, the procurement tool 400 may be the procurement tool 102 of FIG. 1. Included in the procurement tool 400 are a user interface (UI) component 402 that provides user interface elements between one or more users and the procurement tool. These users may be, for example, users 110A, 110B, and 110C of FIG. 1. The UI component 402 may also provide user interface elements for suppliers, such as suppliers 112 of FIG. Thus, the UI component 402 allows for a user interface to be provided whether the user wishes to purchase an item or sell contracted items.

A procurement engine 404 controls various aspect of the procurement process and the interaction between various components of the procurement tool 400. A model 406 interfaces with the procurement engine 404 via a middle tier 408. The model provides much of the interaction between the procurement engine 404 and one or more APIs 410 used to interface with the marketplace system. A database 412 can be used to store various data related to the procurement process, such as purchase orders (POs).

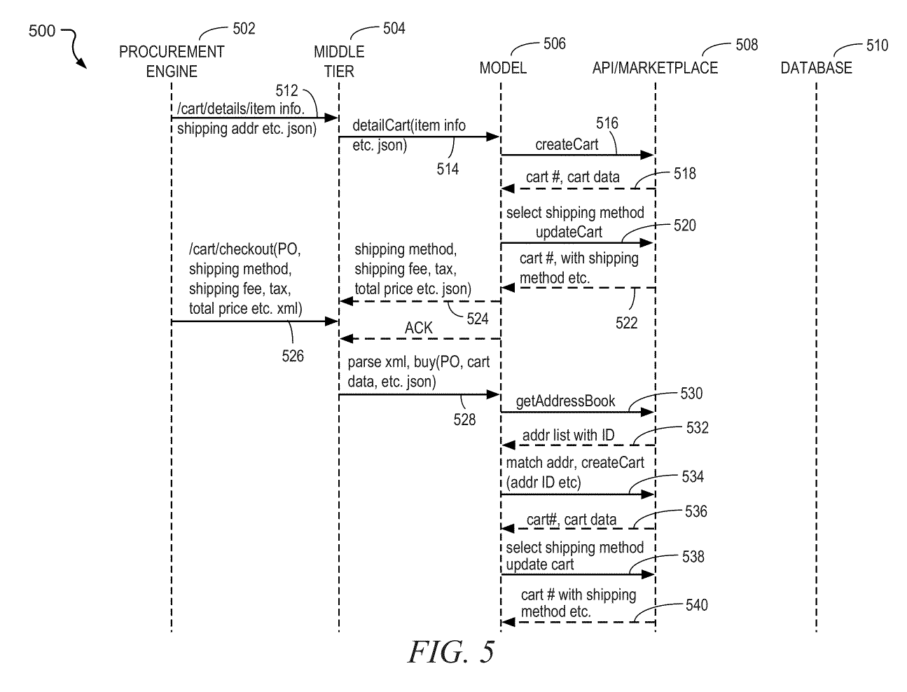

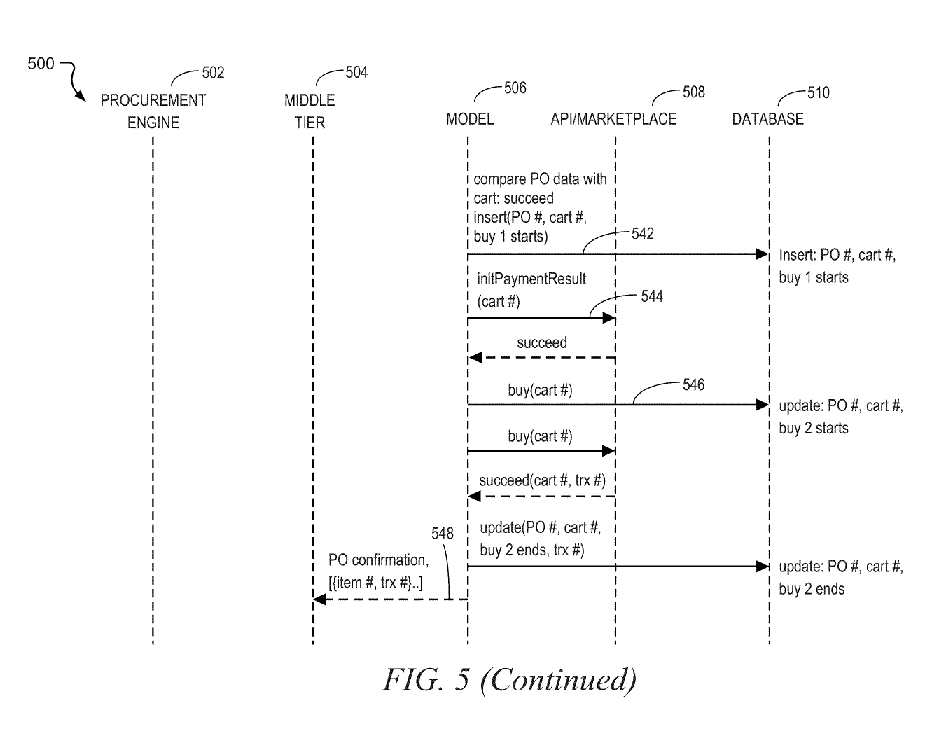

FIG. 5 is a ladder diagram illustrating a method 500 for procuring spot purchase items in accordance with an example embodiment. The method 500 utilizes various components of a procurement tool and surrounding components, such as a procurement engine 502, middle tier 504, model 506, API 508 (which interfaces with a marketplace), and database 510. At operation 512, the procurement engine 502 sends details of a cart (which presumably includes one or more items from the marketplace) to the middle tier 504, which then sends details of the items to the model 506 at operation 514. At operation 516, a cart is created on the marketplace through the API 508. Cart data is then returned at operation 518 along with a request to select shipping method. Once selected, the model 506 updates the cart at operation 520, and at operation 522, the cart is returned with the shipping method and other details such as fees, taxes, total prices, and so forth. This information is then returned to the middle tier at operation 524.

At operation 526, the user then checks out. The cart is parsed by the middle tier 504 at operation 528. At operation 530, the model 506 requests an address book from the API 508, which is then returned at operation 532. At operation 534, the model 508 matches the address and creates a cart and at operation 536, cart data is returned from the API 508. The shipping method may be formally selected at this point. At operation 538, the cart is updated and at operation 540, cart data is returned. If purchase order data matches the cart, then the purchase is a success and information from the purchase order and cart is stored in the database 510 at operation 542. Then at operation 544 payment is initiated. If it is successful then the purchase order is updated in the database 510 at operation 546. Once all purchases on the purchase order have been completed, a confirmation is sent at operation 548.

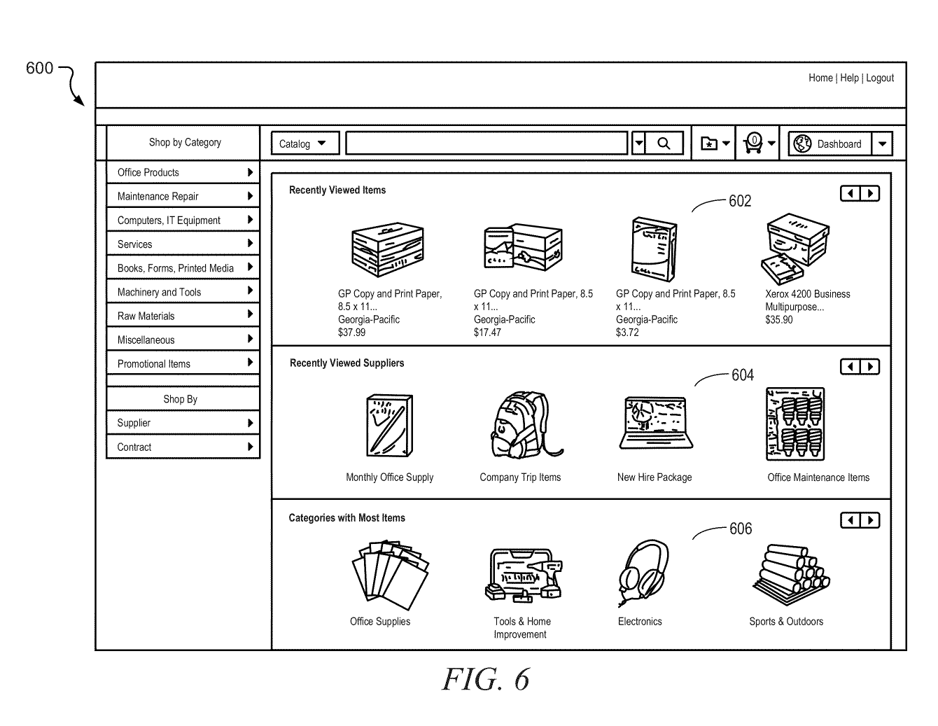

FIG. 6 is a screen capture illustrating a procurement tool 600, in accordance with an example embodiment. Here, the procurement tool 600 allows views of a number of items 602 available for contract purchase, as well as a listing of recently viewed suppliers 604 and categories 606.

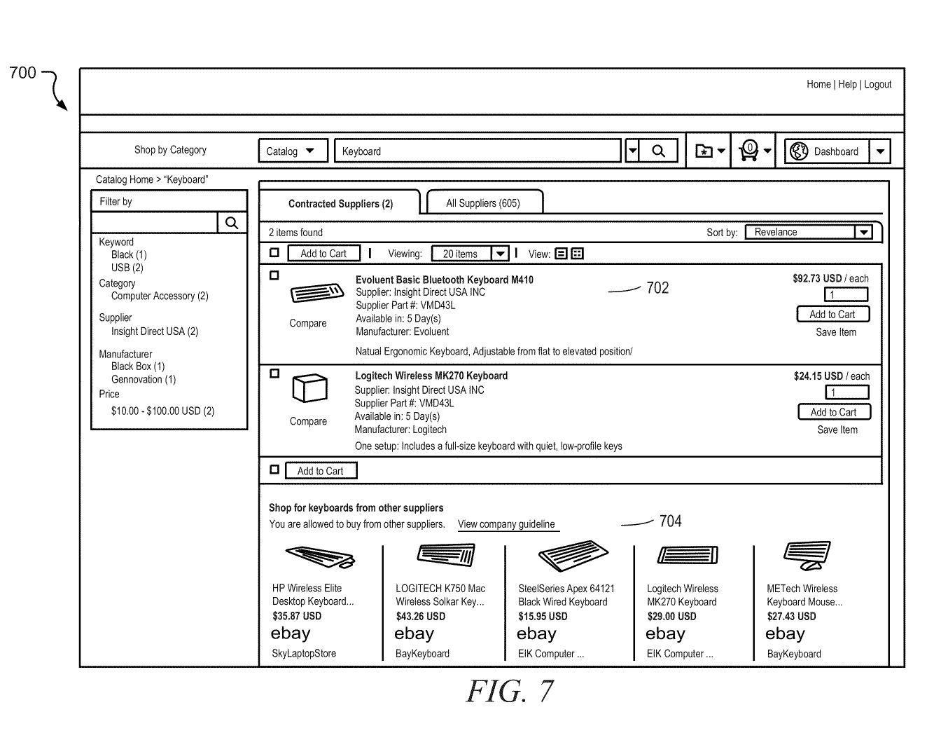

FIG. 7 is a screen capture illustrating a procurement tool 700, in accordance with another example embodiment. Here the user is presented with both items available for contract purchase 702 and items available for spot purchase 704 via a marketplace.

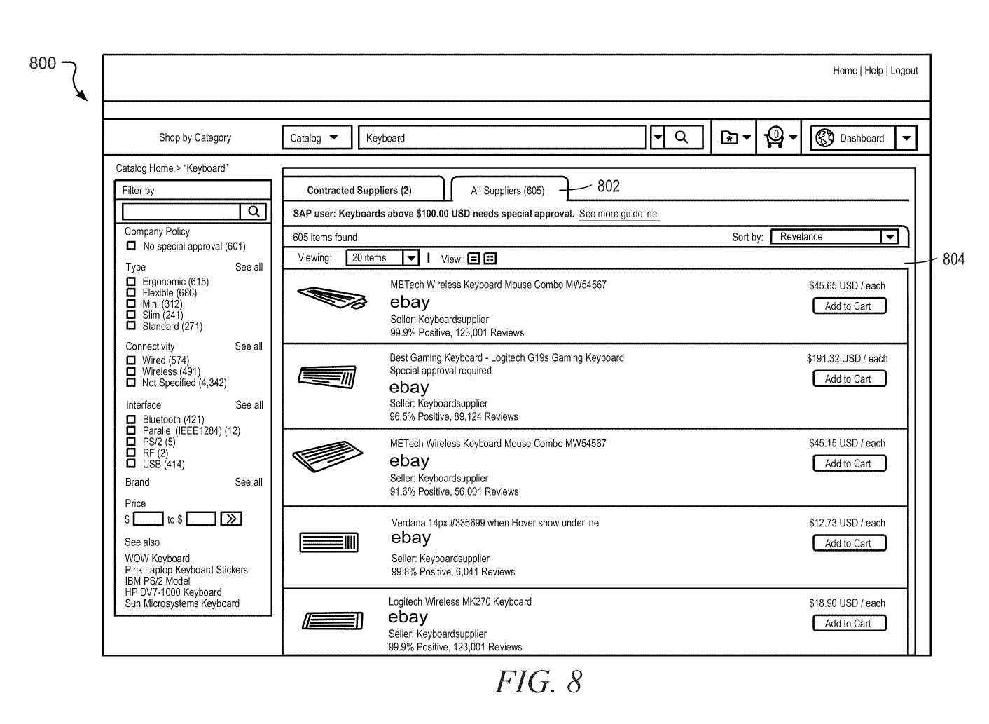

FIG. 8 is a screen capture illustrating a procurement tool 800, in accordance with another example embodiment. Here the user has selected a tab 802 allowing for items available for contract purchase to be presented in the same window 804 as items available for spot purchase.

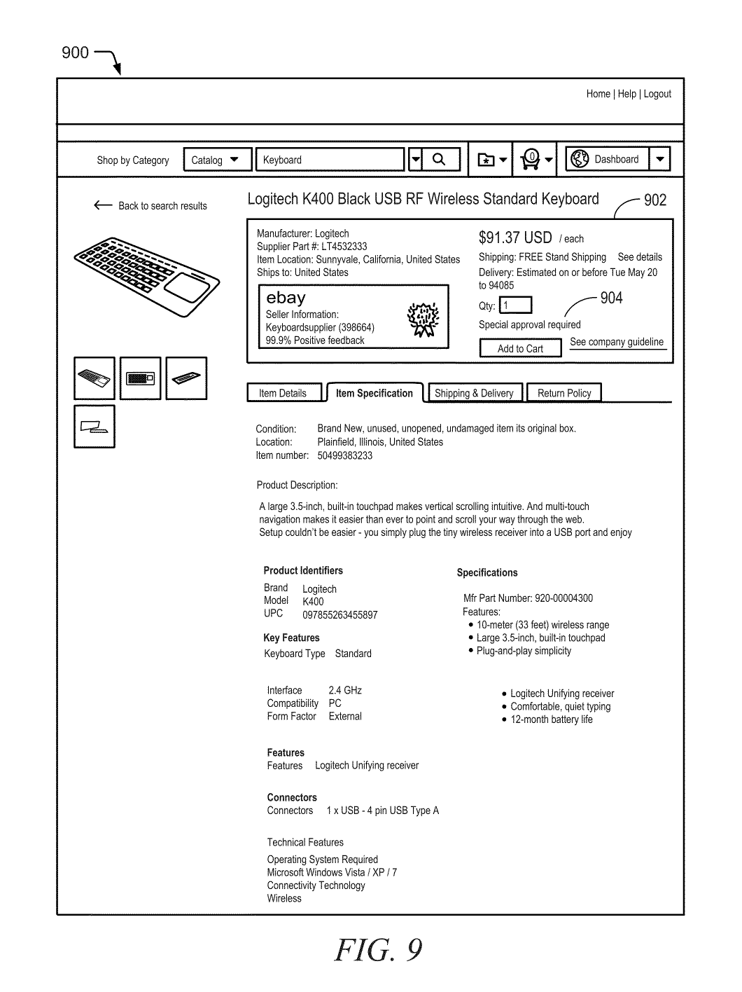

FIG. 9 is a screen capture illustrating a procurement tool 900, in accordance with another example embodiment. Here, the user has selected an individual item and is presented with an item details page 902. Included in this page is an indication that special approval 904 is needed to purchase the item.

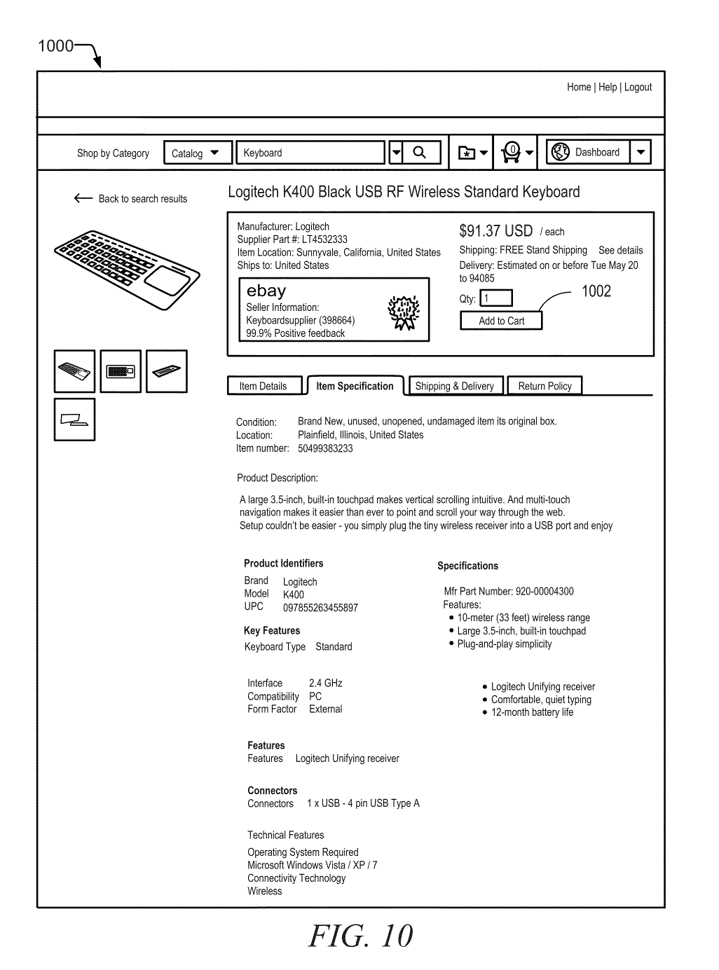

FIG. 10 is a screen capture illustrating a procurement tool 1000, in accordance with another example embodiment. Here, the user has received approval to purchase the item and thus no special approval indication is presented, merely a button 1002 to add the item to the cart.

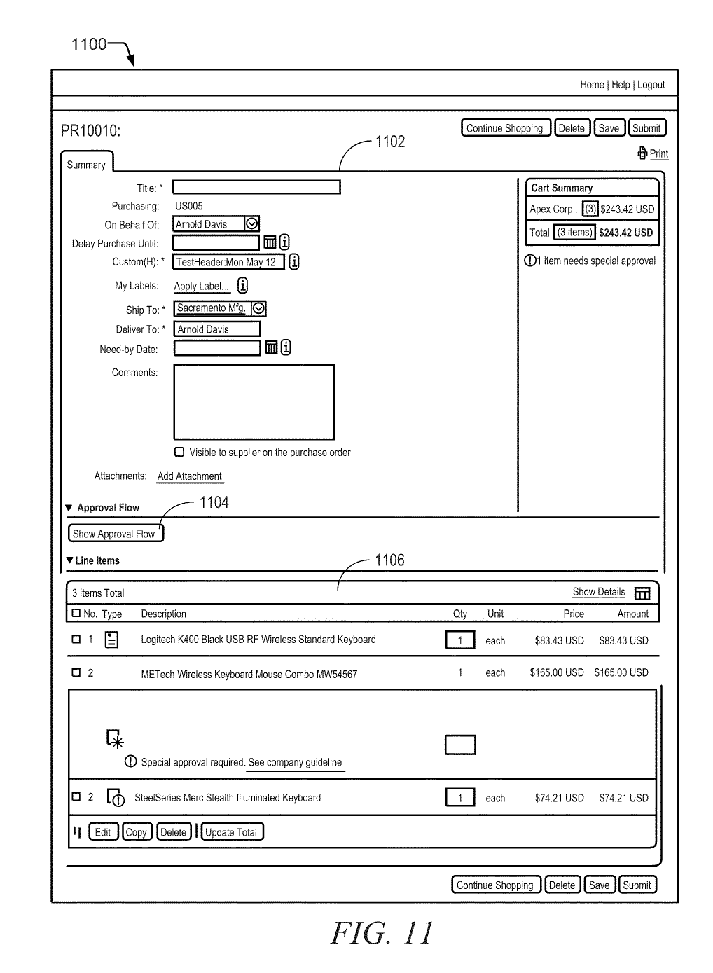

FIG. 11 is a screen capture illustrating a procurement tool 1100, in accordance with another example embodiment. Here, a purchase order 1102 has been generated which can be completed by the appropriate users. An approval flow 1104 can be depicted if approval of other users are needed. A listing of the items 1106 in the purchase order is also provided.

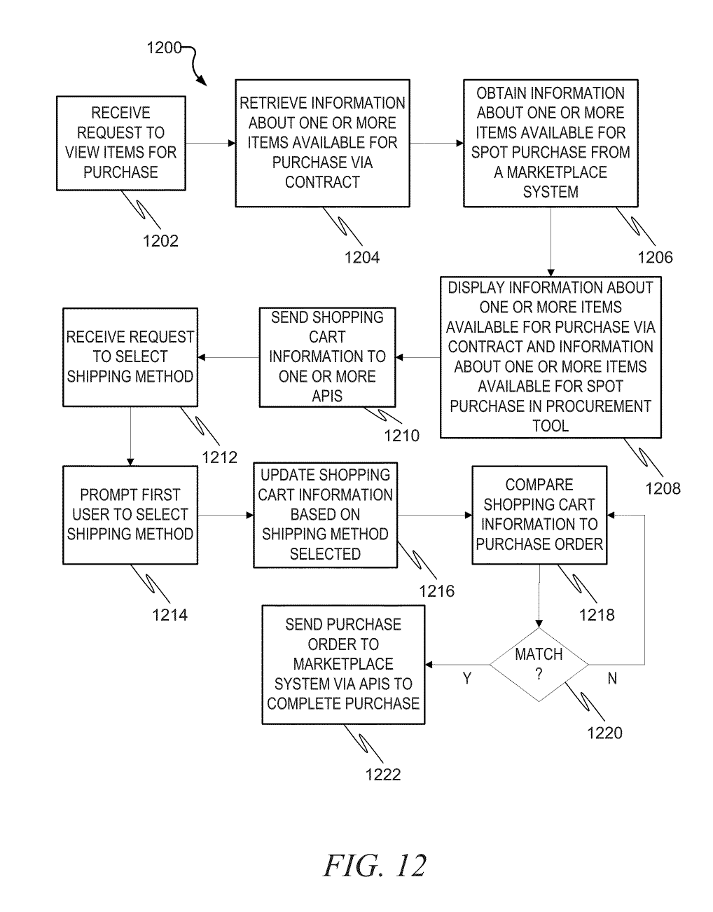

FIG. 12 is a flow diagram illustrating a method 1200, in accordance with an example embodiment. At operation 1202, a request to view items for purchase is received. At operation 1204, information about one or more items available for purchase via contract is retrieved from a database. At operation 1206, information about one or more items available for spot purchase from a marketplace system is obtained via interface with the one or more APIs. At operation 1208, the information about one or more items available for spot purchase and the information about one or more items available for purchase via contract are displayed in a procurement tool. At operation 1210, shopping cart information, containing information about one or more of the items available for spot purchase that have been selected for purchase by a first user, may be sent to the one or more APIs for delivery to the marketplace system. At operation 1212, a request to select a shipping method from the marketplace system is received in response to the sending of the shopping cart information. At operation 1214, the first user is prompted to select the shipping method. At operation 1216, the shopping cart information is updated based on the selection of the shipping method. This may include, for example, calculating a total expense for the items in the shopping cart, including taxes. At operation 1218, the shopping cart information is compared with a purchase order. At operation 1220, it is determined if the shopping cart information matches the purchase order. If so, then at operation 1222, the purchase order is sent to the marketplace system via the one or more APIs to complete purchase.

### Example Mobile Device

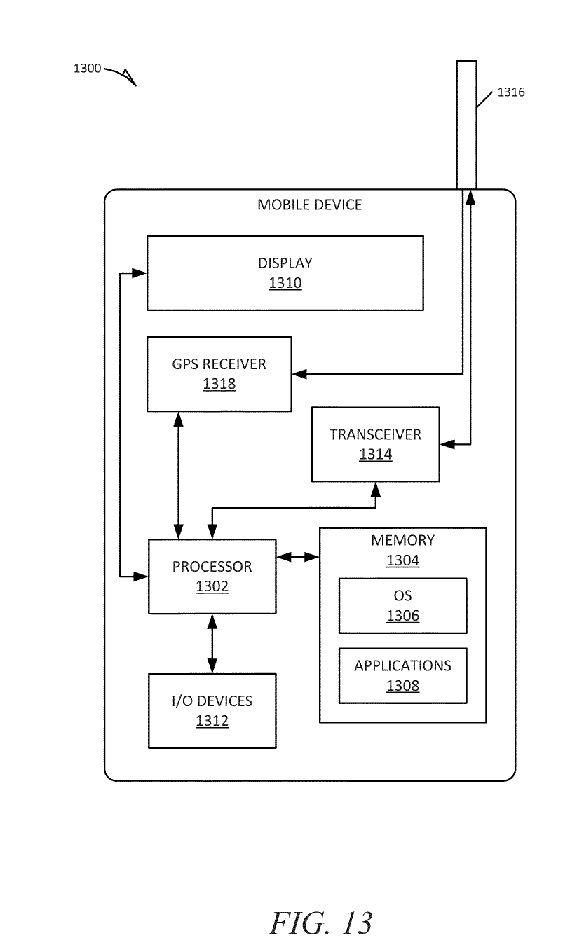

FIG. 13 is a block diagram illustrating a mobile device 1300, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or other type of memory, is typically accessible to the processor 1302. The memory 1304 may be adapted to store an operating system (OS) 1306, as well as application programs 1308, such as a mobile location enabled application that may provide LBSs to a user. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 1302 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor 1302 or other programmable processor 1302) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 1302 configured using software, the general-purpose processor 1302 may be configured as respective different hardware-implemented modules at different times. Software may accordingly configure a processor 1302, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 1302 that are temporarily configured (e.g., by software) or permanently configured to perform the relevant operations. Whether temporarily or permanently configured, such processors 1302 may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors 1302 or processor-implemented modules. The performance of certain of the operations may be distributed among the one or more processors 1302, not only residing within a single machine, but deployed across a number of machines. In some example embodiments, the processor 1302 or processors 1302 may be located in a single location (e.g., within a home environment, an office environment or as a server farm), while in other embodiments the processors 1302 may be distributed across a number of locations.

The one or more processors 1302 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 1302, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 1302 executing a computer program to perform functions by operating on input data and generating output. Method operations can also be performed by, and apparatus of example embodiments may be implemented as, special purpose logic circuitry, e.g., a FPGA or ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor 1202), or a combination of permanently and temporarily configured hardware may be a design choice. Below are set out hardware (e.g., machine) and software architectures that may be deployed, in various example embodiments.

### Example Machine Architecture and Machine-Readable Medium

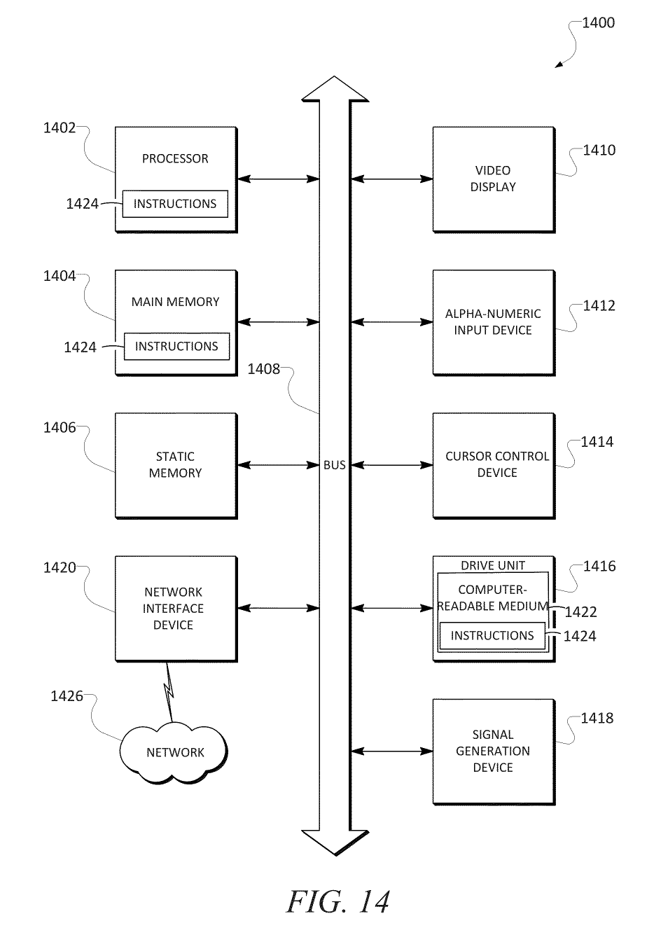

FIG. 14 is a block diagram of machine in the example form of a computer system 1400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term. “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU), or both), a main memory 1404, and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a UI navigation device 1414 (e.g., a mouse), a disk drive unit 1416, a signal generation device 1418 (e.g., a speaker), and a network interface device 1420.

### Machine-Readable Medium

The disk drive unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, with the main memory 1404 and the processor 1402 also constituting machine-readable media 1422.

While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “machine-readable medium” shall also be taken to include any tangible medium that is capable of storing, encoding or carrying instructions 1424 for execution by the machine and that cause the machine to perform any one or more of the methodologies of the present disclosure or that is capable of storing, encoding or carrying data structures utilized by or associated with such instructions 1424. The term “machine-readable medium” shall accordingly be taken to include, but not be limited to, solid-state memories, and optical and magnetic media. Specific examples of machine-readable media 1422 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1424 may further be transmitted or received over a communications network. 1426 using a transmission medium. The instructions 1424 may be transmitted using the network interface device 1420 and any one of a number of well-known transfer protocols (e.g., HTTP). Examples of communication networks include a local area network (LAN), a WAN, the Internet, mobile telephone networks, POTS networks, and wireless data networks (e.g., WiFi and WiMax networks). The term “transmission medium” shall be taken to include any intangible medium that is capable of storing, encoding or carrying instructions 1424 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
one or more application program interfaces (APIs); and
a procurement tool executable by one or more processors and comprising:
a database containing information about items available for purchase via contract;
a user interface (UI) component configured to receive a request to view items for purchase and display information about one or more of the items in the database;
a model configured to obtain one or more items available for spot purchase from a marketplace system via interface with the one or more APIs;
the UI component further configured to display the one or more items available for spot purchase in the procurement tool; and
a procurement engine configured to allow one or more users to purchase one or more of the items available for purchase via contract and one or more of the items available for spot purchase.

2. The system of claim 1, wherein the marketplace system includes an auction server hosting listings in online auctions.

3. The system of claim 1, wherein the procurement engine is further configured to send shopping cart information, containing information about one or more of the items available for spot purchase that have been selected for purchase by a first user to the one or more APIs for delivery to the marketplace system.

4. The system of claim 3, wherein the procurement engine is further configured to receive a request to select a shipping method from the marketplace system in response to the sending of the shopping cart information; and
wherein the UI component is further configured to prompt the first user to select the shipping method.

5. The system of claim 4, wherein the model is further configured to, upon selection by the first user of the shipping method, update the shopping cart information to provide a total price for selected items, including taxes.

6. The system of claim 5, wherein the model is further configured to compare the updated shopping cart information with a purchase order and, if it is determined that the shopping cart information matches the purchase order, send the purchase order to the marketplace system via the one or more APIs to complete purchase.

7. The system of claim 1, wherein the UI component is further configured to display items available for purchase via contract and items available for spot purchase both in a single window.

8. The system of claim 1, wherein the model is further configured to, upon a first user selecting an item available for spot purchase, determine if special approval is needed for the purchase to be completed and, if so, signal the UI component to inform the first user that special approval is needed to purchase the item.

9. The system of claim 6, wherein the model is further configured to, upon a first user selecting an item available for spot purchase, determine if special approval is needed for the purchase to be completed and, if so, signal the UI component to inform the first user that special approval is needed to purchase the item.

10. The system of claim 9, wherein the model is further configured to send the purchase order through an approval flow if special approval is needed for at least one of the items in the shopping cart information.

11. A method comprising:
receiving a request to view items for purchase;
retrieving information about one or more items available for purchase via contract from a database;
obtaining information about one or more items available for spot purchase from a marketplace system via interface with one or more APIs; and
displaying the information about one or more items available for spot purchase and the information about one or more items available for purchase via contract in a procurement tool.

12. The method of claim 11, further comprising sending shopping cart information, containing information about one or more of the items available for spot purchase that have been selected for purchase by a first user to the one or more APIs for delivery to the marketplace system.

13. The method of claim 12, further comprising receiving a request to select a shipping method from the marketplace system in response to the sending of the shopping cart information and prompting the first user to select the shipping method.

14. The method of claim 13, further comprising comparing shopping cart information with a purchase order and, if it is determined that the shopping cart information matches the purchase order, sending the purchase order to the marketplace system via the one or more APIs to complete purchase.

15. The method of claim 11, wherein the displaying includes displaying items available for purchase via contract and items available for spot purchase both in a single window.

16. A non-transitory computer-readable storage medium comprising instructions that, when executed by at least one processor of a machine, cause the machine to perform operations comprising:
receiving a request to view items for purchase;
retrieving information about one or more items available for purchase via contract from a database;
obtaining information about one or more items available for spot purchase from a marketplace system via interface with one or more APIs; and
displaying the information about one or more items available for spot purchase and the information about one or more items available for purchase via contract in a procurement tool.

17. The non-transitory computer-readable storage medium of claim 16, further comprising sending shopping cart information, containing information about one or more of the items available for spot purchase that have been selected for purchase by a first user, to the one or more APIs for delivery to the marketplace system.

18. The non-transitory computer-readable storage medium of claim 17, further comprising receiving a request to select a shipping method from the marketplace system in response to the sending of the shopping cart information and prompting the first user to select the shipping method.

19. The non-transitory computer-readable storage medium of claim 18, further comprising comparing the shopping cart information with a purchase order and; if it is determined that the shopping cart information matches the purchase order, sending the purchase order to the marketplace system via the one or more APIs to complete purchase.

20. The non-transitory computer-readable storage medium of claim 16, wherein the displaying includes displaying items available for purchase via contract and items available for spot purchase both in a single window.
